(19) United States
(12) Patent Application Publication
(10) Pub. No.: US 2025/0263517 A1
(43) Pub. Date: Aug. 21, 2025

(54) Starting Material Composition for Rigid Isocyanurate Foam, Rigid Isocyanurate Foam, and Sound-Absorbing Material

(71) Applicant: Covestro Deutschland AG, Leverkusen (DE)

(72) Inventors: Cheng Chang, Amagasaki (JP); Masaru Suzuki, Sanda-city (JP); Shinichiro Sado, Sanda city (JP)

(21) Appl. No.: 18/859,342

(22) PCT Filed: May 22, 2023
(86) PCT No.: PCT/EP2023/063603

§ 371 Date: Oct. 23, 2024

(30) Foreign Application Priority Data
May 30, 2022 (JP) 2022-088018

(51) Int. Cl. C08G 18/48; E04B 1/86

(52) U.S. Cl. CPC C08G 18/4816; C08G 18/4829; C08G 18/4837; C08G 2110/0025; C08G 2110/0083; E04B 1/86

(57) ABSTRACT

Provided is a starting material composition suitable for producing rigid isocyanurate foam excellent in both energy absorption performance and sound absorption performance, while exhibiting excellent foam moldability, appearance, and air permeability. The starting material composition for rigid isocyanurate foam according to the present disclosure contains a polyol composition and a polyisocyanate. The polyol composition contains a trifunctional or higher-functional polyether polyol (C) having a hydroxy value of 300 mg KOH/g or more, a polyether polyol (A) different from polyether polyol (C) having an ethylene oxide content, based on the total amount of alkylene oxide of polyether polyol (A), of 50 mass % or more, and a polyether polyol (B) different from polyether polyol (C) having an ethylene oxide content, based on the total amount of alkylene oxide of polyether polyol (B), of 10 mass % or less.

### CROSS-REFERENCE TO RELATED APPLICATIONS

This application is the United States national phase of International Patent Application No. PCT/EP2023/063603 filed May 22, 2023, and claims priority to Japanese Patent Application No. 2022-088018 filed May 30, 2022, the disclosures of which are hereby incorporated by reference in their entireties.

### BACKGROUND

### Technical Field

The present invention relates to a starting material composition for rigid isocyanurate foam, a method for producing the rigid isocyanurate foam, the rigid isocyanurate foam, and a sound-absorbing material comprising the rigid isocyanurate foam.

### Description of Related Art

Rigid isocyanurate foam is a type of resin foam obtained by the reaction of a polyol and a polyisocyanate, and is known to be a lightweight material with excellent mechanical properties. Rigid isocyanurate foam with these features is highly useful as it is used across various fields such as the automobile, construction, and civil engineering fields. Rigid isocyanurate foam has been actively improved from various perspectives to further enhance its functionality.

For example, JP2005-272806A discloses a rigid polyurethane foam composed of three layers: a surface high-density layer, an internal low-density layer, and a surface high-density layer, in order to improve shock absorption and sound absorption. JP2013-47338A discloses a sound-absorbing impact absorber composed of a rigid polyisocyanurate foam formed from a specific polyol component and a specific polyisocyanate component.

### SUMMARY

### Technical Problem

However, JP2005-272806A discloses that the rigid polyurethane foam has a compressive stress of 300 to 700 N at 10 to 60%. Given that the stress is assumed to make a curve that increases with displacement, the rigid polyurethane foam is not considered to have sufficient energy absorption performance. The polyurethane foam disclosed in JP2013-47338A lacks stability of cells in the foam and would not necessarily achieve both the sound absorption performance and the energy absorption performance, leaving room for improvement.

In particular, shock absorption performance (energy absorption performance) and sound absorption performance in rigid isocyanurate foam are in a trade-off relationship, and it is not easy to improve both performances. However, energy absorption performance and sound absorption performance are both required in many applications; from this viewpoint, there is strong demand for rigid isocyanurate foam excellent in energy absorption performance and sound absorption performance.

The present invention was made in view of the circumstances above. An object is to provide a starting material composition suitable for producing rigid isocyanurate foam excellent in both energy absorption performance and sound absorption performance, while exhibiting excellent foam moldability, appearance, and air permeability; and to also provide rigid isocyanurate foam and a sound-absorbing material.

### Solution to Problem

The present inventors conducted extensive research to achieve the object and found that the object can be achieved by using a specific polyol composition and a specific polyisocyanate as essential components, and completed the invention.

Specifically, the present invention includes, for example, the subject matter described in the following items.

### Item 1

A starting material composition for rigid isocyanurate foam, the starting material composition comprising a polyol composition and a polyisocyanate,
the polyol composition comprising
   a polyether polyol (A) having an ethylene oxide content, based on the total amount of alkylene oxide of polyether polyol (A), of 50 mass % or more,
   a polyether polyol (B) having an ethylene oxide content, based on the total amount of alkylene oxide of polyether polyol (B), of 10 mass % or less, and
   a trifunctional or higher-functional polyether polyol (C) having a hydroxy value of 300 mg KOH/g or more,
      wherein
the content of component (A) is 30 parts by mass or more and 50 parts by mass or less, and the content of component (C) is 5 parts by mass or more and 35 parts by mass or less, each per 100 parts by mass of the total amount of the starting material composition excluding the polyisocyanate, and
the starting material composition has an isocyanate index of 105 or more and 400 or less.

### Item 2

The starting material composition according to Item 1, wherein the content of component (B) is 10 parts by mass or more and 15 parts by mass or less, per 100 parts by mass of the total amount of the starting material composition excluding the polyisocyanate.

### Item 3

A method for producing a rigid isocyanurate foam comprising the step of letting react the starting material composition according to Item 1 or 2.

### Item 4

A rigid isocyanurate foam obtained by letting react the starting material composition of Item 1 or 2.

### Item 5

A sound-absorbing material comprising the rigid isocyanurate foam of Item 4.

### Advantageous Effects of Invention

The starting material composition for rigid isocyanurate foam according to the present invention is suitable as a starting material for producing rigid isocyanurate foam excellent in both energy absorption performance and sound absorption performance, while exhibiting excellent foam moldability, appearance, and air permeability.

### DETAILED DESCRIPTION

Embodiments of the present invention are described below in detail. In the present specification, the terms “comprising,” “containing,” and “including” include the concepts of “comprising,” “consisting essentially of,” and “consisting of.”

### 1. Starting Material Composition for Rigid Isocyanurate Foam

The starting material composition for rigid isocyanurate foam according to the present invention contains a polyol composition and a polyisocyanate. In the present specification, the starting material composition for rigid isocyanurate foam according to the present invention is simply referred to below as “the starting material composition of the present invention.”

In the starting material composition of the present invention, the polyol composition contains a trifunctional or higher-functional polyether polyol (C) having a hydroxy value of 300 mg KOH/g or more, a polyether polyol (A) different from polyol (C) having an ethylene oxide content, based on the total amount of alkylene oxide of polyether polyol (A), of 50 mass % or more, and a polyether polyol (B) different from polyol (C) having an ethylene oxide content, based on the total amount of alkylene oxide of polyether polyol (B), of 10 mass % or less.

In the starting material composition of the present invention, the content of component (A) is 30 parts by mass or more and 50 parts by mass or less, and the content of component (C) is 5 parts by mass or more and 35 parts by mass or less, each per 100 parts by mass of the total amount of the starting material composition excluding the polyisocyanate. The starting material composition of the present invention has an isocyanate index of 105 or more and 400 or less. The phrase “the total amount of the starting material composition excluding the polyisocyanate” means the total amount of all of the components contained in the starting material composition of the present invention excluding the polyisocyanate.

Because of the polyol composition and the polyisocyanate, the starting material composition of the present invention can produce rigid isocyanurate foam excellent in both energy absorption performance and sound absorption performance, while exhibiting excellent foam moldability, appearance, and air permeability. Specifically, the starting material composition of the present invention is suitable as a starting material for producing rigid isocyanurate foam excellent in both energy absorption performance and sound absorption performance.

### Polyol Composition

The polyol composition, as described above, contains a trifunctional or higher-functional polyether polyol (C) having a hydroxy value of 300 mg KOH/g or more, a polyether polyol (A) different from polyol (C) having an ethylene oxide content, based on the total amount of alkylene oxide of polyether polyol (A), of 50 mass % or more, and a polyether polyol (B) different from polyol (C) having an ethylene oxide content, based on the total amount of alkylene oxide of polyether polyol (B), of 10 mass % or less. In the present specification, these components are respectively simply referred to as “component (C)”, “component (A)”, and “component (B)”. The ethylene oxide content in a more precise sense refers to the content of structural units derived from ethylene oxide based on the total content of structural units derived from alkylene oxide, and means the content of structural units formed by polymerization of ethylene oxide.

Component (A) is a polyether polyol compound with an ethylene oxide unit content, based on the total amount of alkylene oxide of polyether polyol (A), of 50 mass % or more. Component (A) more preferably has an ethylene oxide unit content, based on the total amount of alkylene oxide of polyether polyol (A), of 60 mass % or more, still more preferably 70 mass % or more, and particularly preferably 90 mass % or less. In the context of this invention, a content of a specific alkylene oxide of a specific polyol is to be understood as based on the total amount of alkylene oxide of said specific polyol, except where stated otherwise.

Component (A) may contain one or more additional structural units other than the ethylene oxide unit as long as component (A) has an ethylene oxide unit content, based on the total amount of alkylene oxide of polyether polyol (A), of 50 mass % or more. The additional structural units may be those selected from a wide range of structural units contained in conventional rigid isocyanurate foam. Examples include structural units derived from various cyclic ethers such as alkylene oxide with 3 or more carbon atoms and styrene oxide. The cyclic ethers can be, for example, cyclic ethers described below, and a specific example is a propylene oxide unit. For example, component (A) may be a polyether polyol compound containing an ethylene oxide unit and a propylene oxide unit. Component (A) may also contain a structural unit derived from the polyhydric alcohols described below.

Component (A) has an average number of active hydrogens (f) of preferably 2 or more, more preferably 3 or more, and more preferably 5 or less. An example of active hydrogens of component (A) is a hydroxy group.

In the present specification, the average number of active hydrogens refers to the number of active hydrogens per molecule, in particular the number of hydroxy groups per molecule. The average number of active hydrogens can be controlled by the number of active hydrogens of the initiator for use in synthesis. The average number of active hydrogens (f) can be determined from the hydroxy value (OHV) and the number average molecular weight (Mn) of the polyol according to the following formula:

Average number of active hydrogens (f)=Mn (g/mol)×OHV (mg KOH/g)/56100

Component (A) has a hydroxy value of preferably less than 300 mg KOH/g, more preferably 7 to 87 mg KOH/g, and most preferably 17 to 57 mg KOH/g.

In the present specification, the hydroxy value refers to the value of potassium hydroxide in milligrams necessary for neutralizing the free hydroxy groups (in 1 g of a sample) completely acetylated with acetic anhydride, and means a value measured pursuant to JIS K 1557(2007). Specifically, the hydroxy value is determined as follows. The hydroxy groups in a sample are acetylated with acetic anhydride, and the acetic anhydride that was not involved in acetylation is titrated with a potassium hydroxide ethanol solution. The result is applied to the following formula:

hydroxy value (mg KOH/g)=[((A−B)×f×28.05)/S]+acid value

(A represents the amount (ml) of a 0.5 mol/l potassium hydroxide ethanol solution used in a blank test, B represents the amount (mL) of a 0.5 mol/l potassium hydroxide ethanol solution used in titration, f represents the factor 0.5 (the factor of 0.5 N sodium hydroxide solution), and S represents the amount of a collected sample (g)).

The mass average molecular weight (Mw) of component (A) is not particularly limited, and can be, for example, within the same range as that of polyether polyol compounds for use in the production of conventional rigid isocyanurate foam. For example, the mass average molecular weight (Mw) of component (A) is preferably 1000 or more and 10000 or less. The mass average molecular weight (Mw) as used in the present specification (which is also referred to as “weight average molecular weight”) is one of the average molecular weights of synthesized polymers. If the molecular weight of component i contained in a polymer is Mi, the weight fraction is wi, and the number of molecules is Ni, the mass average molecular weight ΣMiwi is determined according to the following formula.

ΣMiwi=ΣMi²Ni/ΣMiNi

Specifically, the mass average molecular weight refers to the sum of the molecular weights of the individual components of a polymer multiplied by their weight fraction. The mass average molecular weight can be measured by GPC.

Component (A) contained in the polyol composition may be of a single type, or two or more types, i.e., may consist of one polyether polyol or two or more different polyether polyols, in which case each polyether polyol of component (A) has an ethylene oxide unit content, based on the total amount of alkylene oxide of the respective polyether polyol of component (A), of 50 mass % or more.

Component (B) is a polyether polyol compound with an ethylene oxide unit content, based on the total amount of alkylene oxide of polyether polyol (B), of 10 mass % or less. Component (B) preferably has an ethylene oxide unit content, based on the total amount of alkylene oxide of polyether polyol (B), of 5 mass % or less, and more preferably 1 mass % or less. Component (B) may also have an ethylene oxide unit content of 0 mass %; i.e., component (B) may contain no ethylene oxide unit.

Component (B) contains one or more additional structural units other than the ethylene oxide unit. The additional structural units may be those selected from a wide range of structural units contained in conventional rigid isocyanurate foam. Examples include structural units derived from various cyclic ethers such as alkylene oxide with 3 or more carbon atoms and styrene oxide. The cyclic ethers can be, for example, a wide range of the cyclic ethers described below. For example, component (B) may be a polyether polyol compound containing an ethylene oxide unit and a propylene oxide unit. Component (B) may also be a polyether polyol compound that does not contain an ethylene oxide unit, but contains a propylene oxide unit. Component (B) may also contain a structural unit derived from the polyhydric alcohols described below.

Component (B) has an average number of active hydrogens (f) of preferably 2 or more, more preferably 3 or more, and more preferably 5 or less. An example of active hydrogens of component (B) is a hydroxy group.

Component (B) has a hydroxy value of preferably less than 300 mg KOH/g, more preferably 20 to 92 mg KOH/g, and most preferably 36 to 76 mg KOH/g. The hydroxy value of component (B) can be determined in the same manner as for the hydroxy value of component (A), described above.

The mass average molecular weight (Mw) of component (B) is not particularly limited, and can be, for example, within the same range as that of polyether polyol compounds for use in the production of conventional rigid isocyanurate foam. For example, the mass average molecular weight (Mw) of component (B) is preferably 1000 or more and 10000 or less. The mass average molecular weight of component (B) can also be measured by GPC in the same manner as component (A) above.

Component (B) contained in the polyol composition may be of a single type, or two or more types, i.e., may consist of one polyether polyol or two or more different polyether polyols, in which case each polyether polyol of component (B) has an ethylene oxide unit content, based on the total amount of alkylene oxide of the respective polyether polyol of component (B), of 10 mass % or less.

Component (C) is a trifunctional or higher-functional polyether polyol compound with a hydroxy value of 300 mg KOH/g or more. Component (A) and component (B) described above are different from component (C) (in other words, component (A) and component (B) are a polyether polyol compound other than a trifunctional or higher-functional polyether polyol compound with a hydroxy value of 300 mg KOH/g or more).

Component (C) is preferably a tetrafunctional or higher functional polyether polyol compound, and also preferably an octafunctional or lower functional polyether polyol compound. An example of active hydrogens of component (C) is a hydroxy group.

From the standpoint of ease of forming rigid isocyanurate foam excellent in both energy absorption performance and sound absorption performance, component (C) preferably has a hydroxy value of 400 mg KOH/g or more. The upper limit of the hydroxy value of component (C) is not particularly limited, and can be, for example, preferably 800 mg KOH/g or less, and more preferably 500 mg KOH/g or less. The hydroxy value of component (C) can be determined in the same manner as for the hydroxy value of component (A) described above.

The mass average molecular weight (Mw) of component (C) is not particularly limited, and is, for example, preferably 100 or more and 1000 or less. The mass average molecular weight of component (C) can be measured by GPC in the same manner as component (A).

Component (C) is not particularly limited in terms of the type of structural units as long as component (C) is a trifunctional or higher-functional polyether polyol compound with a hydroxy value of 300 mg KOH/g or more. For example, the structural unit contained in component (C) can be those selected from a wide range of structural units contained in conventional rigid isocyanurate foam. Examples include structural units derived from various cyclic ethers such as alkylene oxide with 3 or more carbon atoms and styrene oxide. The cyclic ethers can be, for example, a wide range of the cyclic ethers described below, and a specific example is a propylene oxide unit. Component (C) may also contain a structural unit derived from the polyhydric alcohols described below.

Component (C) contained in the polyol composition may be of a single type, or two or more types, i.e., may consist of one polyether polyol or two or more different polyether polyols, in which case each polyether polyol of component (C) is a trifunctional or higher-functional polyether polyol compound with a hydroxy value of 300 mg KOH/g or more.

The method for producing component (A), component (B), and component (C) is not particularly limited, and these components can be produced, for example, according to a known method. Specifically, these components can be produced by polyaddition of a cyclic ether, condensation of a polyhydric alcohol, or addition polymerization between a cyclic ether and a polyhydric alcohol. The type of the cyclic ether and the polyhydric alcohol as starting materials is not particularly limited and can be suitably selected according to the structure of the polyether polyol compound (target product). In particular, in the production of component (A), the starting material can be selected such that the oxyethylene unit content in component (A) is 50 mass % or more. In the production of component (B), the starting material can be selected such that the oxyethylene unit content in component (B) is 10 mass % or less.

Examples of cyclic ethers include styrene oxide, propylene oxide, tetrahydrofuran, butylene oxide, and epichlorohydrin, in addition to ethylene oxide. These cyclic ethers may be used singly, or in a combination of two or more. Examples of polyhydric alcohols include diol compounds, such as ethane diol, diethylene glycol, triethylene glycol, tetraethylene glycol, 1,2-propanediol, dipropylene glycol, tripropylene glycol, tetrapropylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, and 1,12-dodecanediol; and trifunctional or higher-functional polyols, such as trimethylolpropane, glycerol (glycerine), and pentaerythritol. These polyhydric alcohols may be used singly, or in a combination of two or more. The polyhydric alcohol for producing component (C) is preferably pentaerythritol.

Component (A), component (B), and component (C) may be, for example, commercial products.

The polyol composition may contain other components as long as the polyol composition contains component (A), component (B), and component (C). For example, as long as the effects of the present invention are not impaired, the polyol composition may contain one or more additional polyether polyol compounds other than component (A), component (B), and component (C), or may contain other polyol compounds, such as polyester polyol, polycarbonate polyol, polyester ether polyol, polyester polycarbonate polyol, polylactone polyol, polybutadiene polyol, polymer polyol, or silicone polyol.

The polyol compounds contained in the polyol composition may be only polyether polyol compounds, and may consist of component (A), component (B), and component (C).

The polyol composition may contain various additives for use in producing rigid isocyanurate foam in addition to component (A), component (B), and component (C). Just to note, the polyol composition contains no polyisocyanurate described below.

Examples of additives that can be contained in the polyol composition include a foaming agent, a catalyst, a crosslinking agent, a foam stabilizer, and an emulsifier.

The foaming agent can be of any type and can be selected, for example, from a wide range of known foaming agents used in the production of conventional rigid isocyanurate foam. Examples of foaming agents include chemical foaming agents such as water and carboxylic compounds; and physical foaming agents such as halogenated hydrocarbon compounds, including hydrofluoroolefin and hydrochlorofluoroolefin. The foaming agent contained in the polyol composition is preferably water. The foaming agent contained in the polyol composition can be of a single type, or two or more types.

The content of the foaming agent is not particularly limited, and can be, for example, a content equivalent to that of the foaming agent in known rigid isocyanurate foam. The content of the foaming agent is preferably 1 to 20 mass % based on the total mass of the polyol composition and the polyisocyanate described below.

The catalyst can be of any type, and can be selected, for example, from a wide range of known catalysts used in the production of conventional rigid isocyanurate foam. Preferably, the catalyst is, for example, a catalyst that promotes the reaction between water and an isocyanate (foaming catalyst), a catalyst that promotes the reaction between a polyol and an isocyanate (resinification catalyst), or a catalyst that promotes the trimerization of an isocyanate (i.e., formation of an isocyanurate ring) (trimerization catalyst). The catalyst contained in the polyol composition may be of a single type, or two or more types.

Examples of foaming catalysts include dimorpholine-2,2-diethyl ether, N,N,N′,N″,N″-pentamethyl diethylene triamine, bis(dimethylaminoethyl)ether, 2-(2-dimethylaminoethoxy)ethanol, and N,N,N′-trimethyl-N′-hydroxyethylbisamino ethyl ether.

Examples of resinification catalysts include amine catalysts, such as triethylene diamine, N,N-dimethyl cyclohexylamine, N,N,N″,N′-tetramethylethylene diamine, N,N,N′,N″,N″′,N″′-hexamethyltriethylenetetramine, N-dimethylaminoethyl-N′-methylpiperazine, N,N,N′,N′-tetramethyl hexamethylenediamine, 1,2-dimethylimidazole, 1-isobutyl-2-methylimidazole, N,N-dimethylaminopropylamine, and bis(dimethylaminopropyl)amine; alkanolamine catalysts, such as N,N-dimethylaminoethanol, N,N,N′-trimethyl aminoethyl ethanolamine, N-(3-dimethylaminopropyl)-N,N-diisopropanol amine, N-(2-hydroxyethyl)-N′-methylpiperazine, N,N-dimethylaminohexanol, and 5-dimethylamino-3-methyl-1-pentanol; and metal catalysts, such as tin 2-ethylhexanoate, dibutyltin dilaurate, lead octylate, bismuth carboxylate, and zirconium complexes. These amine catalysts and alkanolamine catalysts for use may be amine carbonate synthesized by adding carbonic acid, or amine carboxylate synthesized by adding carboxylic acid such as formic acid or acetic acid.

Examples of trimerization catalysts include aromatic compounds, such as 2,4,6-tris(dialkylaminoalkyl)hexahydro-S-triazine, 1,3,5-tris(N,N-dimethylaminopropyl)hexahydro-S-triazine, 2,4,6-tris(dimethylaminomethyl)phenol, and 2,4-bis(dimethylaminomethyl)phenol; carboxylic acid alkali metal salts, such as potassium acetate, potassium 2-ethylhexanoate, and potassium octylate; and quaternary ammonium salts of carboxylic acid, and onium salts of carboxylic acid.

The catalyst content in the polyol composition is not particularly limited, and can be, for example, a catalyst content equivalent to that in known rigid isocyanurate foam. The catalyst content is preferably 0.1 to 1 mass % based on the total mass of the polyol composition and the polyisocyanate described below.

The crosslinking agent can be of any type and can be selected, for example, from a wide range of known crosslinking agents used in the production of conventional rigid isocyanurate foam. Examples of crosslinking agents include polyhydric alcohols, such as 1,4-butanediol, ethylene glycol, diethylene glycol, and glycerine: and amines, such as ethanolamine, and polyethylene polyamine. The crosslinking agent contained in the polyol composition may be of a single type, or two or more types.

The content of the crosslinking agent is not particularly limited, and can be, for example, a content of the crosslinking agent equivalent to that in known rigid isocyanurate foam. The content of the crosslinking agent is preferably 0.5 to 5 mass % based on the total mass of the polyol composition and the polyisocyanate described below.

The foam stabilizer can be of any type and can be selected, for example, from a wide range of known foam stabilizers. Examples of foam stabilizers include silicone-based foam stabilizers and fluorine-containing-compound-based foam stabilizers, with silicone-based foam stabilizers being preferable. The foam stabilizer may be of a single type, or a composition formed of a combination of two or more types of stabilizers.

The silicone-based foam stabilizer may be, for example, a silicone foam stabilizer containing a polyoxyalkylene-dimethyl polysiloxane copolymer as a main component. The silicone-based foam stabilizer may be a polyoxyalkylene-dimethyl polysiloxane copolymer alone, or this copolymer with other components in combination. Examples of other components to be combined include polyalkylmethyl siloxane, glycols, and polyoxyalkylene compounds. In another preferable embodiment, the foam stabilizer can be a composition containing two or more members of the following: a polyoxyalkylene-dimethyl polysiloxane copolymer, polyalkylmethyl siloxane, and a polyoxyalkylene compound. From the standpoint of foam stability, this foam stabilizer is advantageous.

Examples of commercial products of foam stabilizers include the following products produced by Momentive: L-580, L-590, L-620, L-680, L-682, L-690, SC-154, SC-155, SC-240, L-598, L-2100, L-2171, SH-210, L-2114, SE-232, L-533, L-534, L-539, M-6682B, L-626, L-627, L-3001, L-3111, L-3415, L-3002, L-3010, L-3222, L-3416, L-3003, L-3333, L-3417, L-2171, L-3620, L-3630, L-3640, L-3170, L-3360, L-3350, L-3555, L-3167, L-3150/L-3151, L-5309, SH-209, and L-3184 (trade names). Other examples of commercial products include the following products produced by Dow Corning Toray Co., Ltd.: SF-2964, SF-2962, SF-2969, SF-2971, SF-2902L, SF-2904, SF-2908, SF-2909, SRX-274C, SZ-1328, SZ-1329, SZ-1330, SZ-1336, SZ-1346, SZ-3601, SRX-294A, SRX-280A, SRX-294A, SRX-298, SH-190, SH-192, and SH-194 (trade names).

The content of the foam stabilizer is not particularly limited, and can be, for example, a content of the foam stabilizer equivalent to that in known rigid isocyanurate foam. The content of the foam stabilizer is preferably 0.5 to 5 mass % based on the total mass of the polyol composition and the polyisocyanate described below.

The emulsifier can be of any type and can be an anionic surfactant, a cationic surfactant, or an ampholytic surfactant. Of these, a nonionic surfactant is preferable. The nonionic surfactant does not dissociate into ions in an aqueous solution, and can be, for example, a surfactant having a hydrophilic atomic group such as a hydroxy group (—OH), an ether bond (—O—), an ester group (—COOR), or a carbamoyl group (—CONH2), and a long-chain lipophilic atomic group such as an alkyl group or an alkyl-substituted aryl group in the molecule. Specific nonionic surfactants include ethylene oxide-based nonionic surfactants, polyoxyalkyl ether, polyoxyalkyl aryl ether, polyoxyalkylene alkyl ether, polyoxyalkylamine, fatty acid ester-based nonionic surfactants, polyoxyalkylene fatty acid ester, polyethylene glycol dioleate, polyoxyethylene fatty acid diester, polyglycerine fatty acid ester, polyanhydrosorbitol fatty acid ester, and polyethylenimine.

The content of the emulsifier is not particularly limited, and can be, for example, a content of the emulsifier equivalent to that in known rigid isocyanurate foam. The content of the foam stabilizer is preferably 0.5 to 10 mass % based on the total mass of the polyol composition and the polyisocyanate described below.

The polyol composition may contain various other components in addition to the foaming agent, catalyst, crosslinking agent, foam stabilizer, and emulsifier described above. Examples include additives such as anti-sedimentation agents, foam breakers, antioxidants, UV absorbers, light stabilizers, plasticizers, flame retardants, water repellents, antimicrobial agents, antifungal agents, pigments, and dyes. These additives for use can be selected from a wide range of those used in the production of conventional rigid isocyanurate foam, and each additive can be used alone, or in a combination of two or more.

### Polyisocyanate

The starting material composition of the present invention contains a polyisocyanate as an essential component. The polyisocyanate is a compound having two or more isocyanate groups.

The polyisocyanate can be of any type and can be selected from a wide range of, for example, aliphatic, alicyclic, aromatic, or aromatic aliphatic polyisocyanates.

Examples of aromatic polyisocyanates include phenylene diisocyanate, tolylene diisocyanate, xylylene diisocyanate, diphenylmethane diisocyanate, dimethyl diphenylmethane diisocyanate, triphenylmethane triisocyanate, naphthalene diisocyanate, and polymethylene polyphenyl polyisocyanate. Examples of alicyclic polyisocyanates include cyclohexylene diisocyanate, methylcyclohexylene diisocyanate, isophorone diisocyanate, dicyclohexyl methane diisocyanate, and dimethyl dicyclohexylmethane diisocyanate. Examples of aliphatic polyisocyanates include methylene diisocyanate, ethylene diisocyanate, propylene diisocyanate, tetramethylene diisocyanate, and hexamethylene diisocyanate.

The polyisocyanate may be a polyisocyanate-modified product. Examples include polyisocyanates having a structure such as uretdione, isocyanurate, urethane, urea, allophanate, biuret, carbodiimide, iminooxadiazinedione, oxadiazinetrione, or oxazolidone. The polyisocyanate for use may be an isocyanate group-containing prepolymer obtained by reacting a polyol with a polyisocyanate.

The polyisocyanate contained in the starting material composition may be of a single type, or two or more types i.e., may consist of one polyisocyanate or two or more different polyisocyanates.

### Starting Material Composition

The starting material composition of the present invention, as described above, contains the polyol composition and the polyisocyanate.

The starting material composition of the present invention has an isocyanate index of 105 or more and 400 or less. An isocyanate index within this range provides a starting material composition from which it is easier to produce rigid isocyanurate foam excellent in both energy absorption performance and sound absorption performance.

The isocyanate index refers to a value obtained by multiplying the ratio of the isocyanate groups in the polyisocyanate component to the sum of active hydrogen atoms that react with isocyanate groups in the polyol composition by 100. The active hydrogen atoms that react with the isocyanate groups in the polyol composition are derived from, for example, the polyol components. If the foaming agent is, for example, carboxylic acid or water, these foaming agents also have active hydrogen reactive with isocyanate groups.

From the standpoint of ease of producing rigid isocyanurate foam excellent in both energy absorption performance and sound absorption performance, the isocyanate index is preferably 120 or more, more preferably 130 or more, still more preferably 140 or more, and particularly preferably 180 or more; and also preferably 300 or less, more preferably 220 or less, still more preferably 200 or less, and particularly preferably 190 or less.

The starting material composition may contain other components as long as the starting material composition contains the polyol composition and the polyisocyanate. The starting material composition may also consist of the polyol composition and the polyisocyanate. In the present invention, because the components other than the polyisocyanate are all considered to constitute the polyol composition, the starting material composition of the present invention preferably consists of the polyol composition and the polyisocyanate.

In the starting material composition of the present invention, the content of component (A) and the content of component (C) are, as described above, determined as follows. Specifically, the content of component (A) is 30 parts by mass or more and 50 parts by mass or less, and the content of component (C) is 5 parts by mass or more and 35 parts by mass or less, each per 100 parts by mass of the total amount of the starting material composition excluding the polyisocyanate. A content of component (A) in the starting material composition of less than 30 parts by mass may lead to decreased air permeability of the rigid isocyanurate foam, resulting in failure to achieve a desired sound absorption coefficient. A content of component (A) exceeding 50 parts by mass may make it difficult to adjust the reactivity during the production of rigid isocyanurate foam, resulting in failure to achieve desired shock absorption performance. A content of component (C) in the starting material composition of less than 5 parts by mass may result in failure to form rigid isocyanurate foam. A content of component (C) in the starting material composition exceeding 35 parts by mass may lead to decreased air permeability of the rigid isocyanurate foam, resulting in failure to achieve a desired sound absorption coefficient.

In the starting material composition, the phrase “the total amount of the starting material composition excluding the polyisocyanate” means, for example, the total amount of all of the components contained in the starting material composition excluding the polyisocyanate. Thus, if the starting material composition consists of a polyol composition and a polyisocyanate, “the total amount of the starting material composition excluding the polyisocyanate” is synonymous with the total amount of the polyol composition. In the context of the present application, contents of components of the polyol composition in parts per mass are to be understood as per 100 parts by mass of the total amount of the starting material composition excluding the polyisocyanate, except where stated otherwise.

The content of component (A) is preferably 32 parts by mass or more, preferably 48 parts by mass or less, more preferably 46 parts by mass or less, still more preferably 45 parts by mass or less, and particularly preferably 40 parts by mass or less, per 100 parts by mass of the total amount of the starting material composition excluding the polyisocyanate.

The content of component (C) is preferably 10 parts by mass or more, more preferably 13 parts by mass or more, still more preferably 15 parts by mass or more, and particularly preferably 20 parts by mass or more, per 100 parts by mass of the total amount of the starting material composition excluding the polyisocyanate.

The content of component (C) is also preferably 34 parts by mass or less, more preferably 32 parts by mass or less, and still more preferably 30 parts by mass or less, per 100 parts by mass of the total amount of the starting material composition excluding the polyisocyanate.

The content of component (B) in the starting material composition is not particularly limited. From the standpoint of ease of producing rigid isocyanurate foam excellent in both energy absorption performance and sound absorption performance, the content of component (B) is preferably 10 parts by mass or more and 15 parts by mass or less, per 100 parts by mass of the total amount of the starting material composition excluding the polyisocyanate.

The method for preparing the starting material composition is not particularly limited. For example, the starting material composition can be prepared by mixing the polyol composition and the polyisocyanate in a predetermined ratio. The method for preparing the polyol composition is also not particularly limited. For example, the polyol composition can be obtained by mixing component (A), component (B), and component (C), with optional additives in a predetermined ratio. For example, it is preferred that the polyol composition and the polyisocyanate are mixed at a constant liquid temperature. In this case, the liquid temperature is, for example, preferably 25 to 35° C. This makes it likely for the viscosity and flowability of the composition to fall within appropriate ranges, making the filling of the composition better. This results in reduced voids in rigid isocyanurate foam. In the preparation of the polyol composition, the components other than a foaming agent may be added beforehand, and then mixed with a foaming agent.

### 2. Rigid Isocyanurate Foam

The starting material composition of the present invention can be used as a starting material for producing rigid isocyanurate foam. Specifically, rigid isocyanurate foam can be produced by using the starting material composition. Thus, the rigid isocyanurate foam is a molded foam product of the starting material composition.

The method for obtaining rigid isocyanurate foam by using the starting material composition is not particularly limited. For example, a wide range of known production methods for rigid isocyanurate foam can be used in the present invention. Thus, rigid isocyanurate foam can be produced by foaming the starting material composition according to an appropriate method, and optionally molding it.

The method for foaming the starting material composition is not particularly limited, and the method for use can be a known foaming technique such as hand-mixing foaming, simple foaming, continuous foaming, injection foaming, frothing injection foaming, or spray foaming. The method for molding rigid isocyanurate foam is also not particularly limited, and the method for use can be a known molding technique such as mold molding, slab molding, laminate molding, or in-situ foam molding.

In molding the rigid isocyanurate foam, the surface temperature of the mold is preferably 50 to 70° C. This makes the reactivity moderate and allows for better filling of the starting material composition into the mold. The demolding time (the time from the start of injecting the composition for foam production to the start of mold opening for the molded article) is preferably 120 to 600 seconds, and more preferably 180 to 360 seconds. Open molding allows rigid isocyanurate foam to be molded in a short time, thus easily increasing production efficiency.

As described above, rigid isocyanurate foam is obtained by using the starting material composition of the present invention; i.e., the rigid isocyanurate foam is foam of the starting material composition of the present invention.

The shape and size of the rigid isocyanurate foam are not particularly limited and can be suitably determined according to the intended use.

The rigid isocyanurate foam can have any density. The density of the rigid isocyanurate foam is, for example, preferably 20 to 200 kg/m3, and more preferably 40 to 140 kg/m3. The density of rigid isocyanurate foam can be measured pursuant to JIS K 7222:1999.

The air permeability of the rigid isocyanurate foam is, for example, 1 to 80 L/min, and preferably 2 to 60 L/min. This makes it easier to impart excellent sound absorption performance to the rigid isocyanurate foam. The air permeability of the rigid isocyanurate foam can be measured pursuant to JIS K6400-7A (negative-pressure method).

Because the rigid isocyanurate foam is formed from the starting material composition of the present invention, the rigid isocyanurate foam is excellent in both energy absorption performance and sound absorption performance.

Because the energy absorption performance and sound absorption performance are in a trade-off relationship, it has been difficult to achieve both. However, because the rigid isocyanurate foam is formed from the starting material containing a polyol composition and a polyisocyanate, which are specific components, the rigid isocyanurate foam is excellent in both performances.

Thus, the rigid isocyanurate foam formed from the starting material composition of the present invention has a wide range of applications in which energy absorption performance and sound absorption performance are required. For example, the rigid isocyanurate foam can be used in various areas, such as vehicles, marine vessels, plants, heat insulating equipment, construction, civil engineering, furniture, and interior decorating; in particular, due to its excellent energy absorption performance and sound absorption performance, the rigid isocyanurate foam is suitable for automotive interior parts.

The rigid isocyanurate foam of the present invention can also be widely used in areas in which either energy absorption performance or sound absorption performance is required; for example, the rigid isocyanurate foam can be suitably used in various safety components because of its excellent shock absorption performance.

### 3. Sound-Absorbing Material

The rigid urethane foam can be used as a sound-absorbing material because of its excellent sound absorption performance. Such a sound-absorbing material is not particularly limited as long as the sound-absorbing material contains the rigid isocyanurate foam. For example, the sound-absorbing material can be structured in the same manner as known sound-absorbing materials. The sound-absorbing material may be formed by combining the rigid isocyanurate foam with other components, or may be formed of only the rigid isocyanurate foam.

The sound-absorbing material of the present invention is excellent in both energy absorption performance and sound absorption performance because the sound-absorbing material contains the rigid isocyanurate foam obtained from the starting material composition described above. Thus, the sound-absorbing material of the present invention can be suitably used as an automotive interior part.

In another embodiment of the sound-absorbing material of the present invention, a sound-absorbing material can be obtained by using a composition for sound-absorbing materials that contains a polyol composition containing component (A), component (B), and component (C) and a polyisocyanate. Specifically, rigid isocyanurate foam formed by foaming and molding the composition for sound-absorbing materials may be used as a sound-absorbing material. The sound-absorbing material in this embodiment is also excellent in both energy absorption performance and sound absorption performance.

### EXAMPLES

The following describes the present invention in more detail with reference to Examples. However, the present invention is not limited to the embodiments of these Examples.

To produce the rigid isocyanurate foam of the Examples and Comparative Examples, starting materials were suitably selected from the starting materials shown below (polyol composition and polyisocyanate).

### Polyol Composition

A polyol composition was prepared by selecting materials from the following component (A), component (B), component (C), crosslinking agent, catalysts, foam stabilizer, foaming agent, and emulsifiers.

### Component (A)

Addition polymerization was performed on glycerine with propylene oxide and ethylene oxide, thereby obtaining polyether polyol (A) with an average number of active hydrogens (f) of 3.0, a hydroxy value of 37 mg KOH/g, a mass average molecular weight of about 4500, and an ethylene oxide unit content of 70 mass %.

### Component (B)

Addition polymerization was performed on glycerine with propylene oxide, thereby obtaining polyether polyol (B) with an average number of active hydrogens (f) of 3.0, a hydroxy value of 56 mg KOH/g, and a mass average molecular weight of about 3000.

### Component (C)

Addition polymerization was performed on pentaerythritol with propylene oxide, thereby obtaining polyether polyol (C) with an average number of active hydrogens (f) of 4.0, a hydroxy value of 410 mg KOH/g, and a mass average molecular weight of about 487.

### Crosslinking Agent

Crosslinking agent 1: glycerine (produced by Kao Corporation)

### Catalyst

Catalyst: DABCO BL-11 (produced by Evonik Industries AG)
Catalyst: DABCO EG (produced by Evonik Industries AG)
Catalyst 3: DABCO K-15 (produced by Evonik Industries AG)
Catalyst 4: potassium acetate

### Foaming Agent

Water

### Foam Stabilizer

SRX-280A (produced by Dow Corning Toray Co., Ltd.)

### Emulsifier

Emulsifier 1: EMALEX DEG-di-O (produced by Nihon Emulsion Co., Ltd.)
Emulsifier 2: IONET DO-600 (produced by Sanyo Chemical Industries, Ltd.)

### Polyisocyanate

Polymethylene polyphenyl polyisocyanate (isocyanate group content: 31.5 mass %)

### Example 1

In accordance with the formulation of Table 1, a starting material composition containing a polyol composition and a polyisocyanate was prepared as follows. First, 40 parts by mass of component (A), 12 parts by mass of component (B), and 5 parts by mass of component (C), and additives (a crosslinking agent, catalysts, a foam stabilizer, and emulsifiers) were mixed in a mixing pot in the formulation shown in Table 1. A foaming agent was then added to the obtained mixture in the formulation shown in Table 1 to prepare a polyol composition. While this polyol composition was kept at 30° C., a polyisocyanate was added thereto in such an amount so as to give the isocyanate index shown in Table 1, followed by mixing with stirring. The mixture in a liquid form was injected to a mold, foamed, and cured. Foaming was performed with a high-pressure foam-molding machine by injecting the polyol composition into a mold. In this step, the composition of the present invention was prepared as a single composition by mixing a polyol mixture and a polyisocyanate, and then injected into a mold. The high-pressure foam-molding machine for use was Model A System 40 produced by Canon Inc. Open injection was performed for mold molding at a discharge amount of 200 to 250 g/sec, a mixing pressure of 15 MPa, and an injection time of 0.5 to 0.8 sec, thereby obtaining a molded article (200 mm×200 mm×50 mm). During mold-molding, the surface temperature was kept at or around 60° C. Desired rigid isocyanurate foam was obtained by the above operations.

### Examples 2 to 13

Rigid isocyanurate foam was obtained in the same manner as in Example 1, except that the type and amount of the starting materials were changed as shown in Table 1.

### Comparative Examples 1 to 4

Rigid isocyanurate foam was obtained in the same manner as in Example 1, except that the type and amount of the starting materials were changed as shown in Table 1.

### Evaluation Method

The density, air permeability, sound absorption coefficient, the presence or absence of free foam, compressive strength, and compressive stress of the rigid isocyanurate foam (test specimen) obtained in each of the Examples and Comparative Example were measured.

### Sound Absorption Coefficient

The sound absorption coefficient of the rigid isocyanurate foam was measured pursuant to JIS A1405-2. A sound absorption coefficient at 2000 Hz of 10% or more was determined to be pass (preferably 15% or more), and a sound absorption coefficient at 3150 Hz of 20% or more was determined to be pass.

### Free Foam Formation and Appearance

Separately, starting material compositions prepared in the same manner as in the Examples and Comparative Examples in accordance with the formulations shown in Table 1 were individually added to a 2 L cup, foamed, and cured. Foaming was performed with a high-pressure foam-molding machine by injecting the individual polyol compositions into a mold. In this step, the composition of the present invention was prepared as a single composition by mixing a polyol mixture and a polyisocyanate, and then injected into a mold. The high-pressure foam-molding machine for use was Model A System 40 produced by Canon Inc. Open injection was performed for mold molding at a discharge amount of 250 g/sec, a mixing pressure of 15 MPa, and an injection time of 0.4 sec, thereby obtaining a sample for free foam evaluation. The appearance of the obtained samples (rise and collapse of foam, whether shrinkage has occurred) was visually observed and evaluated based on the following criteria.

A: Excellent foam rise with no collapse, and there was also no shrinkage or deformation.
B: There was collapse, and the foam did not rise, or shrank or deformed.

### Compressive Strength, Compressive Stress, and Energy Absorption Performance

Rigid isocyanurate foam cut into pieces of 50 mm×50 mm×50 mm was used as measurement samples. The measurement device for use was a precision universal tester (produced by MinebeaMitsumi Inc.). A measurement sample was placed flat in the center of the table of the tester, and then a pressure plate was placed on the top surface of the test specimen. The thickness of the sample when the load reached 1 N (initial thickness measurement load) was read up to a 0.1 mm unit, and this thickness was determined to be the initial thickness. Subsequently, the pressure plate was pressed into the measurement sample at a rate of 10 mm/min, until the thickness reached 80% of the initial thickness, and the load at this time was determined to be compressive strength (N) of the rigid isocyanurate foam. The compressive stress was calculated according to the following formula.

$$Compressive stress ( N / m 2 ) = compressive load ( N ) / area of compressed surface ( m 2 )$$

The energy absorption performance was evaluated based on the value of the increase in compressive stress represented by the following formula.

$$Increase in compressive stress ( \% ) = [ \text{} ( the maximum stress when the measured sample is compressed by 50 \% ) - ( the maximum stress when the measured sample is compressed by 10 \% ) ] \text{} / ( the maximum stress when the measured sample is compressed by 10 \% ) \times 100$$

An increase in compressive stress of 40% or less was determined to be pass (the sample having excellent energy absorption performance).

### Density

The density of the rigid isocyanurate foam was measured pursuant to JIS K 7222:1999.

### Air Permeability

The air permeability of the rigid isocyanurate foam was measured pursuant to JIS K6400-7A (negative-pressure method). An air permeability of 0.5 L/min or more was determined to be pass. In this measurement, the core part of the rigid isocyanurate foam (50 mm×50 mm×25 mm) was used as a measurement sample.

| | | | Example | | | | | | | | |
|---|---|---|---|---|---|---|---|---|---|---|---|
| | | | 1 | 2 | 3 | 4 | 5 | 6 | 7 | 8 | 9 |
| Formulation | Polyol Composition | Component (A) | 40 | 40 | 40 | 40 | 40 | 40 | 40 | 40 | 40 |
| of Starting | (parts by mass) | Component (B) | 12 | 12 | 12 | 12 | 12 | 12 | 12 | 12 | 12 |
| Material | | Component (C) | 5 | 10 | 30 | 30 | 30 | 30 | 40 | 30 | 30 |
| Composition | | Crosslinking Agent | 5.0 | 5.0 | 5.0 | 5.0 | 5.0 | 5.0 | 5.0 | 5.0 | 5.0 |
| | | Catalyst 1 | 0.4 | 0.4 | 0.4 | 0.4 | 0.4 | 0.4 | 0.4 | 0.4 | 0.4 |
| | | Catalyst 2 | 0.4 | 0.4 | 0.4 | 0.4 | 0.4 | 0.4 | 0.4 | 0.4 | 0.4 |
| | | Catalyst 3 | 0.5 | 0.5 | 0.5 | 0.5 | 0.5 | 0.5 | 0.5 | 0.5 | 0.5 |
| | | Catalyst 4 | 0.2 | 0.2 | 0.2 | 0.2 | 0.2 | 0.2 | 0.2 | 0.2 | 0.2 |
| | | Foaming Agent | 6 | 6 | 6 | 6 | 6 | 6 | 6 | 6 | 6 |
| | | Foam Stabilizer | 1.5 | 1.5 | 1.5 | 1.5 | 1.5 | 1.5 | 1.5 | 1.5 | 1.5 |
| | | Emulsifier 1 | 10.0 | 10.0 | 10.0 | 10.0 | 10.0 | 10.0 | 10.0 | 10.0 | 10.0 |
| | | Emulsifier 2 | 2.5 | 2.5 | 2.5 | 2.5 | 2.5 | 2.5 | 2.5 | 2.5 | 2.5 |

| | | | | | | | | | | |
|---|---|---|---|---|---|---|---|---|---|---|
| | Total Mass of Polyol Composition | 83.5 | 88.5 | 108.5 | 108.5 | 108.5 | 108.5 | 118.5 | 108.5 | 108.5 |
| | (pats by mass) | | | | | | | | | |
| | Content of Component (A) Per 100 | 47.9 | 45.2 | 36.9 | 36.9 | 36.9 | 36.9 | 33.8 | 36.9 | 36.9 |
| | Parts by Mass of Polyol Composition | | | | | | | | | |
| | (parts by mass) | | | | | | | | | |
| | Content of Component (B) Per 100 | 14.4 | 13.6 | 11.1 | 11.1 | 11.1 | 11.1 | 10.1 | 11.1 | 11.1 |
| | Parts by Mass of Polyol Composition | | | | | | | | | |
| | (parts by mass) | | | | | | | | | |
| | Content of Component (C) Per 100 | 6.0 | 11.3 | 27.7 | 27.7 | 27.7 | 27.7 | 33.8 | 27.7 | 27.7 |
| | Parts by Mass of Polyol Composition | | | | | | | | | |
| | (parts by mass) | | | | | | | | | |
| | Polyisocyanate (parts by mass) | 262.2 | 257.4 | 141.4 | 161.6 | 188.5 | 242.4 | 236.8 | 242.4 | 242.4 |
| | Isocyanate Index | 180 | 180 | 105 | 120 | 140 | 180 | 180 | 180 | 180 |
| Evaluation | Free Foam Formation and | A | A | A | A | A | A | A | A | A |
| Item for | Appearance | | | | | | | | | |
| Foam | Air Permeability (L/min) | 20 | 20 | 70 | 44 | 41 | 8 | 7 | 8 | 7.5 |
| | Sound Absorption Coefficient@2000 | 92.5% | 92.5% | 63.0% | 72.1% | 98.8% | 57.2% | 57.2% | 67.7% | 67.4% |
| | Hz | | | | | | | | | |
| | Sound Absorption Coefficient@3150 | 94.8% | 91.8% | 87.2% | 96.0% | 89.3% | 65.4% | 67.4% | 77.2% | 76.1% |
| | Hz | | | | | | | | | |
| | Compressive Strength (N) | 2.5 | 2.7 | 2.8 | 3.2 | 3.4 | 3.8 | 3.8 | 5.6 | 7.8 |
| | Compressive Stress (N/m²) | 1.0 | 1.1 | 1.1 | 1.2 | 1.3 | 1.5 | 1.5 | 2.0 | 2.7 |
| | Increase in Compressive Stress | 25% | 25% | 40% | 36% | 36% | 38% | 39% | 38% | 38% |
| | (Energy Absorption Performance) | | | | | | | | | |
| | Density (kg/m³); 50T Flat Plate | 65 | 65 | 65 | 65 | 65 | 65 | 65 | 80 | 100 |

| | | | Example | | | | Comparative Example | | | | |
|---|---|---|---|---|---|---|---|---|---|---|---|
| | | | 10 | 11 | 12 | 13 | 1 | 2 | 3 | 4 | 5 |
| Formulation | Polyol Composition | Component (A) | 40 | 40 | 40 | 40 | 40 | 40 | 40 | 40 | 40 |
| of Starting | (parts by mass) | Component (B) | 12 | 12 | 12 | 12 | 12 | 12 | 12 | 12 | 0 |
| Material | | Component (C) | 30 | 30 | 30 | 30 | 0 | 50 | 30 | 30 | 30 |
| Composition | | Crosslinking Agent | 5.0 | 5.0 | 5.0 | 5.0 | 5.0 | 5.0 | 5.0 | 5.0 | 5.0 |
| | | Catalyst 1 | 0.4 | 0.4 | 0.4 | 0.4 | 0.4 | 0.4 | 0.4 | 0.4 | 0.4 |
| | | Catalyst 2 | 0.4 | 0.4 | 0.4 | 0.4 | 0.4 | 0.4 | 0.4 | 0.4 | 0.4 |
| | | Catalyst 3 | 0.5 | 0.5 | 0.5 | 0.5 | 0.5 | 0.5 | 0.5 | 0.5 | 0.5 |
| | | Catalyst 4 | 0.2 | 0.2 | 0.2 | 0.2 | 0.2 | 0.2 | 0.2 | 0.2 | 0.2 |
| | | Foaming Agent | 6 | 6 | 6 | 6 | 6 | 6 | 6 | 6 | 6 |
| | | Foam Stabilizer | 1.5 | 1.5 | 1.5 | 1.5 | 1.5 | 1.5 | 1.5 | 1.5 | 1.5 |
| | | Emulsifier 1 | 10.0 | 10.0 | 10.0 | 10.0 | 10.0 | 10.0 | 10.0 | 10.0 | 10.0 |
| | | Emulsifier 2 | 2.5 | 2.5 | 2.5 | 2.5 | 2.5 | 2.5 | 2.5 | 2.5 | 2.5 |

| | | | | | | | | | | |
|---|---|---|---|---|---|---|---|---|---|---|
| | Total Mass of Polyol Composition | 108.5 | 108.5 | 109.5 | 109.5 | 78.5 | 128.5 | 108.5 | 109.5 | 96.5 |
| | (pats by mass) | | | | | | | | | |
| | Content of Component (A) Per 100 | 36.9 | 36.9 | 36.5 | 36.5 | 51.0 | 31.1 | 36.9 | 36.5 | 41.5 |
| | Parts by Mass of Polyol Composition | | | | | | | | | |
| | (parts by mass) | | | | | | | | | |
| | Content of Component (B) Per 100 | 11.1 | 11.1 | 11.0 | 11.0 | 15.3 | 9.3 | 11.1 | 11.0 | 0.0 |
| | Parts by Mass of Polyol Composition | | | | | | | | | |
| | (parts by mass) | | | | | | | | | |
| | Content of Component (C) Per 100 | 27.7 | 27.7 | 27.4 | 27.4 | 0.0 | 38.9 | 27.7 | 27.4 | 31.1 |
| | Parts by Mass of Polyol Composition | | | | | | | | | |
| | (parts by mass) | | | | | | | | | |
| | Polyisocyanate (parts by mass) | 269.4 | 296.3 | 404.0 | 538.7 | 267.7 | 232.06 | 141.4 | 606.0 | 269.1 |
| | Isocyanate Index | 200 | 220 | 300 | 400 | 180 | 180 | 100 | 450 | 180 |
| Evaluation | Free Foam Formation and | A | A | A | A | B | A | A | B | A |
| Item for | Appearance | | | | | | | | | |
| Foam | Air Permeability (L/min) | 2 | 1.5 | 1 | 1 | — | 0 | 70 | — | 0 |
| | Sound Absorption Coefficient@2000 | 23.1% | 22.1% | 18.6% | 15.2% | — | 40.5% | 63.0% | — | 24.3% |
| | Hz | | | | | | | | | |
| | Sound Absorption Coefficient@3150 | 32.7% | 31.2% | 27.5% | 23.1% | — | 53.4% | 87.2% | — | 34.7% |
| | Hz | | | | | | | | | |
| | Compressive Strength (N) | 3.7 | 3.9 | 4.7 | 5.8 | — | 4.2 | 2.8 | — | 2.7 |
| | Compressive Stress (N/m²) | 1.5 | 1.5 | 1.6 | 2.1 | | 1.7 | 1.1 | — | 1.1 |
| | Increase in Compressive Stress | 23% | 23% | 21% | 17% | — | 41% | 76% | — | 37% |
| | (Energy Absorption Performance) | | | | | | | | | |
| | Density (kg/m³); 50T Flat Plate | 65 | 65 | 65 | 65 | — | 65 | 65 | — | 65 |

As shown in Table 1, the rigid isocyanurate foam obtained in the Examples was evaluated as good in free foam formation and appearance, and as excellent in foam moldability, appearance, and air permeability. In Comparative Example 1, the physical properties could not be measured due to defective free foam formation. The rigid isocyanurate foam obtained in Comparative Examples 2 and 5 had an air permeability of “0,” clearly indicating the lack of desired sound absorption performance.

Every rigid isocyanurate foam obtained in the Examples also had a sound absorption coefficient at 2000 Hz of over 10%, indicating excellent sound absorption performance. The rigid isocyanurate foam obtained in the Examples showed a smaller increase in compressive stress (40% or less) when compressed by 10% to 50% and showed a high keeping rate, indicating excellent energy absorption performance. Thus, the rigid isocyanurate foam obtained from the starting material containing a specific polyol composition and a specific polyisocyanate was found to be excellent in both sound absorption performance and energy absorption performance.

1. A starting material composition for rigid isocyanurate foam, the starting material composition comprising a polyol composition and a polyisocyanate,
the polyol composition comprising
a trifunctional or higher-functional polyether polyol (C) having a hydroxy value of 300 mg KOH/g or more,
a polyether polyol (A) different from polyol (C) having an ethylene oxide content, based on the total amount of alkylene oxide of polyether polyol (A), of 50 mass % or more, and
a polyether polyol (B) different from polyol (C) having an ethylene oxide content, based on the total amount of alkylene oxide of polyether polyol (B), of 10 mass % or less,
wherein
the content of component (A) is 30 parts by mass or more and 50 parts by mass or less, and the content of component (C) is 5 parts by mass or more and 35 parts by mass or less, each per 100 parts by mass of the total amount of the starting material composition excluding the polyisocyanate, and
the starting material composition has an isocyanate index of 105 or more and 400 or less.

2. The starting material composition according to claim 1, wherein the content of component (B) is 10 parts by mass or more and 15 parts by mass or less, per 100 parts by mass of the total amount of the starting material composition excluding the polyisocyanate.

3. A method for producing a rigid isocyanurate foam comprising the step of letting react the starting material composition according to claim 1.

4. A rigid isocyanurate foam obtained by letting react the starting material composition of claim 1.

5. A sound-absorbing material comprising the rigid isocyanurate foam of claim 4.
